(19) United States
(12) Patent Application Publication
(10) Pub. No.: US 2012/0170466 A1
(43) Pub. Date: Jul. 5, 2012

(54) JOINT SUBCARRIER USAGE RATIO AND POWER ALLOCATION METHOD, SYSTEM USING THE SAME, BASE STATION AND CONTROLLER USING THE SAME

(75) Inventors: Chiao Lee, Taichung City (TW); Li-Chun Wang, Hsinchu City (TW); Jane-Hwa Huang, Tainan City (TW)

(73) Assignees: NATIONAL CHIAO TUNG UNIVERSITY, Hsinchu City (TW); INDUSTRIAL TECHNOLOGY RESEARCH INSTITUTE, Hsinchu (TW)

(21) Appl. No.: 12/980,355

(22) Filed: Dec. 29, 2010

(51) Int. Cl. H04W 72/04; H04W 24/00

(52) U.S. Cl. 370/252; 370/329

(57) ABSTRACT

A joint subcarrier usage ratio and power allocation method, the system and base station, and a controller using the same are proposed. The method is adapted for a femtocell base station using OFDMA technology to jointly select transmission power and subcarrier usage ratio. The method includes a first adjustment process, which simultaneously, dynamically and jointly adjusts the transmission power and the subcarrier usage ratio so as to quickly satisfy capacity requirement and link reliability requirement. The method also includes a second adjustment process for slowly adjusting the transmission power and the subcarrier usage ratio after the capacity requirement and the link reliability requirement are both met in the first adjustment process for stability duration. The second adjustment process helps the femtocell base station achieve maximal power efficiency. An outer-loop control might be used in the method to relax the capacity requirement of one femtocell for quickly achieving a stable situation.

### BACKGROUND

1. Technical Field

The disclosure relates to a joint subcarrier usage ratio and power allocation method for femtocell using orthogonal frequency division multiple access (OFDMA) technology, a wireless communication system using the same, a base station and a controller using the same.

2. Related Art

Currently, femtocell is an ultra-small indoor base station for integrating home-based fixed network and mobile communication system, and the femtocell could improve communication quality of mobile phones in indoor environment. Femtocell base stations are usually deployed by users in indoor environment for low power consumption wireless mobile communication and use the existing fixed broadband networks as backhaul networks with mobile communication operators. In order to speed up development of femtocell network architectures, manufacturers and associated research institutes established Femto Forum in July of 2007. The Femto Forum actively promotes standard development of the femtocell base stations, educates market, and establishes industry supply chain, exchanges market information and technology. Members of the Femto Forum include telecom operators, equipment suppliers (hardware, software, chipset design house and system integration manufacturers) and so forth. The Femto Forum even cooperates with Next Generation Mobile Network (NGMN) for actively promoting the femtocell network architectures in next generation mobile networks, so as to achieve optimized femtocell system performance.

Moreover, femtocell is regarded as an important technology in next generation communication systems. In particular, the femtocell could operate at lower transmission power and could be realized at lower manufacturing costs, so as to effectively improve data transmission rate and signal coverage area of wireless communication in indoor environment. However, when femtocell systems are broadly applied and deployed, a femtocell is greatly impacted by cellular macrocell base stations and other neighboring femtocells. That is, signals of a femtocell base station could be interfered by signals from cellular macrocell base stations, and could also be interfered by signals from the neighboring femtocells, such that data transmission rate of the femtocell is too low and wireless link quality of the femtocell base station is unstable.

Although there are many conventional approaches raised to solve the aforementioned problem, but most of related arts just individually process on the transmission power control scheme of the femtocell base station, or just individually process on selection of wireless channels or selection of quantity of wireless channels. Moreover, the legacy centralized frequency planning and power control techniques cannot be used to solve problems of interference of a femtocell base station to neighboring femtocells since femtocell base stations are mostly deployed by users rather than telecom operators. The literature also pointed out that the femtocells will significantly interfere with each other. One technical study shows that when the deployment density of femtocells is high (e.g., 100 femtocells/km²), in order to maintain a high transmission success rate (e.g., the link reliability probability Pᵣₑₗ=0.9), a femtocell base station normally could just use 60% subcarriers (or subchannels). Therefore, it is an important issue in the femtocell systems to simultaneously take care of data transmission rate and wireless link quality and meanwhile lower signal interference to other neighboring base stations in a distributed manner.

### SUMMARY

A joint subcarrier usage ratio and power allocation method is introduced herein. The joint subcarrier usage ratio and power allocation method is adapted for a base station using OFDMA technology, where the base station itself uses the method to autonomously select power and a subcarrier usage ratio. The method includes an adjustment process, and the adjustment process simultaneously, dynamically and jointly adjusts the power and the subcarrier usage ratio, so as to meet predetermined capacity requirement and link reliability requirement.

A joint subcarrier usage ratio and power allocation method is introduced herein. The joint subcarrier usage ratio and power allocation method is adapted for at least a base station using OFDMA technology within a coverage area of a large cell, where the base station uses the method to select power and a subcarrier usage ratio. The method could estimate a deployment density of at least a base station within the coverage thereof, computes a parameter set mapping table by off-line simulation, and regularly broadcasts the femtocell deployment density and the parameter set mapping table to the corresponding base stations.

A wireless communication system is introduced herein. The wireless communication system includes at least a base station, where the at least a base station uses OFDMA technology, and simultaneously, dynamically and jointly adjusts the power and the subcarrier usage ratio, so as to meet predetermined capacity requirement and link reliability requirement.

A wireless communication system is introduced herein. The wireless communication system includes a controller, adapted for estimating a deployment density of at least a base station within the coverage thereof, computing a parameter set mapping table by off-line simulation, and regularly broadcasting the femtocell deployment density and the parameter set mapping table to the corresponding base stations.

A base station is introduced herein. The femtocell base station is adapted for simultaneously, dynamically and jointly adjusting the power and the subcarrier usage ratio. The femtocell bases station uses OFDMA technology and includes a calculation unit, an adjustment unit and a comparison unit. The calculation unit calculates link reliability and a subcarrier usage ratio. The adjustment unit adjusts power and the subcarrier usage ratio. The comparison unit determines whether current capacity is greater than or equal to a predetermined capacity threshold, and determines whether the link reliability is greater than or equal to a predetermined link reliability threshold.

A controller is introduced herein. The controller is adapted for managing at least a first type base station, and includes a registration unit and a calculation unit. The registration unit performs registration procedures with the at least a first type base station after the at least a first type base station initiates the registration procedures. The calculation unit obtains feasible solutions for each one of femtocell deployment densities by off-line simulations, and estimates femtocell deployment density in a coverage area of a second type base station, wherein the at least a first type base station is within the coverage area of the second type base station.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic diagram illustrating a large cell base station along with femtocells within the coverage of the large cell.

FIG. 2 is a schematic diagram illustrating resultant power efficiency along with link quality obtained by simulation of jointly subcarrier usage ratio and power allocation approach of a femtocell base station.

FIG. 3A-FIG. 3D are four schematic diagrams respectively illustrating top views of FIG. 2 under different powers and subcarrier usage ratios.

FIG. 4A is a flowchart illustrating a joint subcarrier usage ratio and power allocation method according to an exemplary embodiment.

FIG. 4B is a flowchart illustrating another joint subcarrier usage ratio and power allocation method according to another exemplary embodiment.

FIG. 5 is a flowchart illustrating a fine adjustment process as illustrated in FIG. 4.

FIG. 6 is a functional block diagram illustrating a femtocell base station according to an exemplary embodiment.

FIG. 7 is a functional block diagram illustrating a controller according to an exemplary embodiment.

### DESCRIPTION OF THE EXEMPLARY EMBODIMENTS

Reference will now be made in detail to explain the exemplary embodiments of the present disclosure, examples of which are illustrated in the accompanying drawings. Wherever possible, the same reference numbers are used in the drawings and the description to refer to the same or like parts.

The basic principle of exemplary embodiments in the present disclosure mainly proposes a joint subcarrier usage ratio and power allocation method for femtocell systems using OFDMA technology, along with a wireless communication system using the same method and a bases station and a controller using the same method. The power is transmission power of the femtocell base station. The subcarrier usage ratio refers to the ratio of the number of subcarriers used by a femtocell to the total number of available subcarriers, and the subcarrier usage ratio could be regarded as subchannel usage ratio or channel usage ratio in OFDMA technology. The proposed joint subcarrier usage ratio and power allocation method could be applied in most wireless communication systems such as Worldwide Interoperability for Microwave Access (WiMAX) system, 3GPP Long Term Evolution (LTE) system and the wireless communication systems using OFDMA technology.

The proposed method could use a distributed management approach to make a femtocell operate in adequate power and channel usage ratio, and meanwhile ensure capacity of the users as well as the signal reliability (or the link reliability) of the users of the femtocell. Here, the capacity could be regarded as downlink wireless transmission rate in the disclosure. The link reliability could be regarded as the successful transmission probability. Also, the proposed method simultaneously, dynamically and integrally adjusts the power and the subcarrier usage ratio, so as to effectively manage respective power control and respective adjust subcarrier usage ratios among femtoecells. Therefore, the proposed method not only solves the problems of mutual interference between femtocells, but also further manages power of each femtocell base station, in order to avoid unnecessary power consumption.

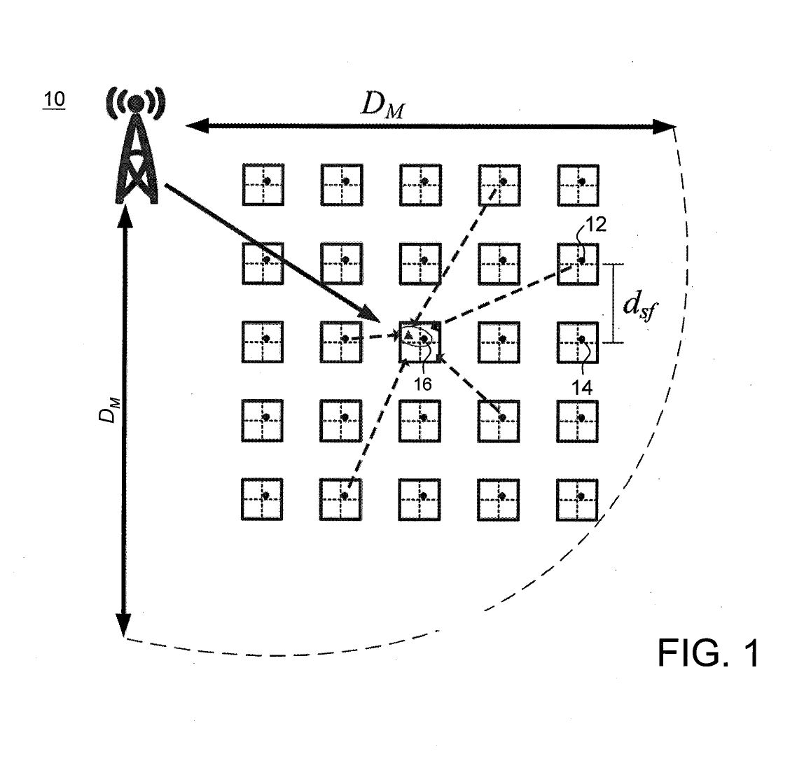

FIG. 1 is a schematic diagram illustrating a large cell base station 10 along with femtocells within the coverage of the large cell. Throughout the disclosure, the large cell refers to a cellular marcrocell or a cellular microcell. Coverage diameter of the large cell base station 10 is D_{M}, and the coverage area thereof includes a plurality of femtocells. In order to perform simulation and computation on associated wireless communication capacity, link reliability and power, the femtocells are evenly distributed in FIG. 1. However, the even distribution of the femtocells in FIG. 1 could statistically represent an overall picture of locations of randomly deployed femtocells since the situation of randomly deployed femtocells could be effectively simulated by adjusting average deployment density of femtocells. The average deployment density of femtocells is also correlated with femtocell spacing d_{sf} (e.g., a spacing distance between the femtocell 12 and the femtocell 14 shown in FIG. 1).

Referring to the deployment scenario of the femtocells in FIG. 1, there are many indoor environments in a deployment area of a femtocell within coverage area of the large cell, where each indoor environment occupies, for example, 10 m². Also, a femtocell is allocated in each indoor environment, where each indoor environment is divided into four rooms. By observing the femtocell 16 in FIG. 1, the signal interference experienced by the femtocell 16 are mainly two types. The first type of signal interference comes from interference of large cell base station, and the second type of signal interference comes from interference of other neighboring femtocells. These two types of signal interference could greatly impact upon the link reliability and capacity (transmission rate) of the femtocell 16.

In the joint subcarrier usage ratio and power allocation method, power and subcarrier usage ratio (channel usage ratio) are both important. When a first type base station (the femtocell base station) experiences interferences from both cellular macrocell and other femtocell base stations, the problems solved by power and subcarrier usage ratio (channel usage ratio) are actually different. The control of power is in fact ineffective to reduce the signal interferences between femtocells, since when one of the femtocells increases power, other femtocells would also increase their own power in response to such initial power increase of the femtocell, and thus increase interference between femtocells. Eventually, all femtocells return to original state due to power increase but on the other hand, the interference from macrocell could be overcome by increasing power of femtocells. Since a second type base station (the large cell base station 10, which is also the cellular macrocell base station) uses all of bandwidth, subcarrier usage ratio (channel usage ratio) of femtocells is thus ineffective to reduce the interference from large cell base station 10. However, adjustment of subcarrier usage ratio (channel usage ratio) of femtocell could effectively lower mutual interferences between femtocells. As such, it is reasonable and necessary to consider both power and subcarrier usage ratio when the femtocell experience two aforementioned interferences.

In an OFDMA system, the subcarrier usage ratio and transmission power are flexible adjustment parameters. When a first type base station (the femtocell) experiences signal interferences from a second type has station (macrocells) and other first type base station (femtocells), how to adequately control the subcarrier usage ratio in order to lower mutual interference probability between the femtocells, and select adequate power to balance the signal interferences from macrocells is thus an important issue. When the femtocell uses too great power, it causes great signal interference to users of other femtocells as well as uses of the macrocells. On the other hand, when the femtocell uses too small power, the users of the femtocell could experience unaccepted link reliability. Similarly, when the femtocell uses too high subcarrier usage ratio, the probability of interfering the users of other femtocell or the macrocells is thus increased. When the femtocell uses too low subcarrier usage ratio, the capacity of the users of the femtocell is thus limited.

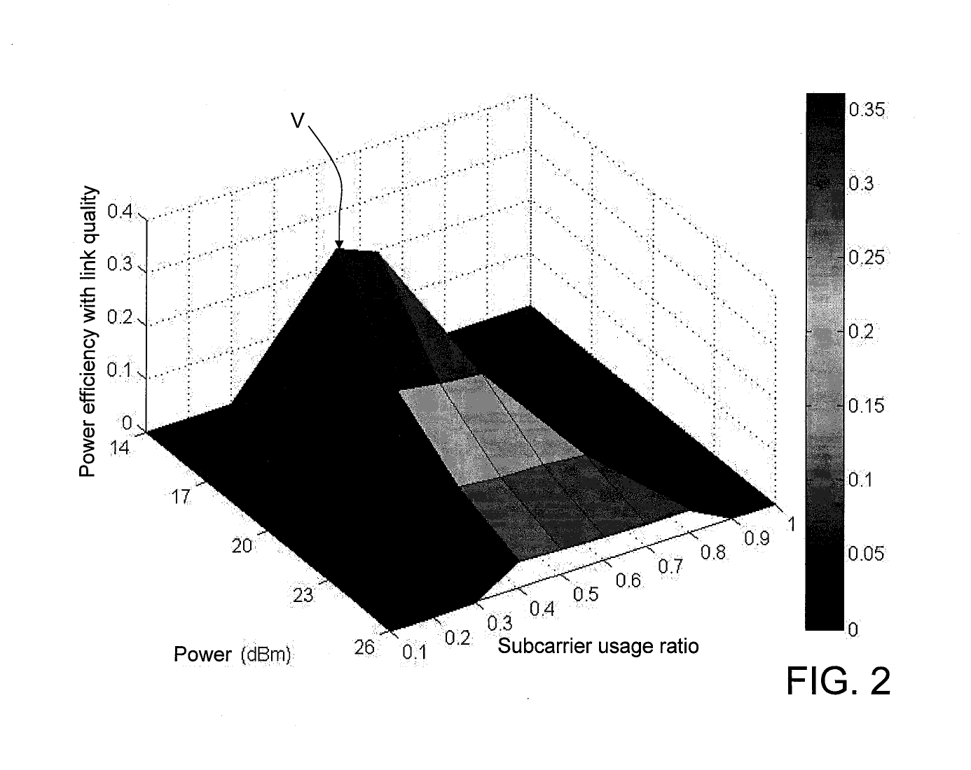

FIG. 2 is a schematic diagram illustrating resultant power efficiency along with link quality obtained by simulation of jointly subcarrier usage ratio and power allocation approach of a femtocell base station. The large cell base station 10 in FIG. 1 and simulation results of FIG. 2 are just for exemplary illustration. Under a situation when multiple reasonable parameters are selected, the generated simulation results are not limited to those shown in FIG. 2. In a simulation environment corresponding to the simulation result shown in FIG. 2, the major fixed parameters are: there are 24 neighboring femtocells around the femtocell 16, and the spacing between the femtocell is d_{sf}=20 m as shown in FIG. 1. On the other hands, the simulation result for the corresponding major variable parameters shown in FIG. 2 are three-dimensional, where the variable parameters include power (in dBm) and subcarrier usage ratio, and power efficiency along with an ensured link reliability is the third dimension. The power efficiency is the transmission power efficiency of the femtocell 16, which is defined as a ratio of the achieved throughput of one femtocell to the total transmission power of the femtocell.

The portion similar to a triangular pyramid shown in FIG. 2 is feasible solution area. The feasible solution area is a situation where both the link reliability condition and capacity condition are met (or satisfied). The vertex V in the feasible solution area is a special case where the maximal power efficiency is achieved with an ensured link reliability. By observing the simulation result of FIG. 2, multiple approaches to concurrently meet the link reliability requirement and capacity requirement in the joint subcarrier usage ratio and power allocation method could be found. For simplicity of illustration, the proposed joint subcarrier usage ratio and power allocation method mainly simultaneously and dynamically adjust the power and the subcarrier usage ratio under the acceptable condition of capacity and link reliability. When the feasible solution area is achieved, a fine adjustment process is performed to select a parameter set of adequate subcarrier usage ratio and power, so as to further achieve the situation of the maximal power efficiency.

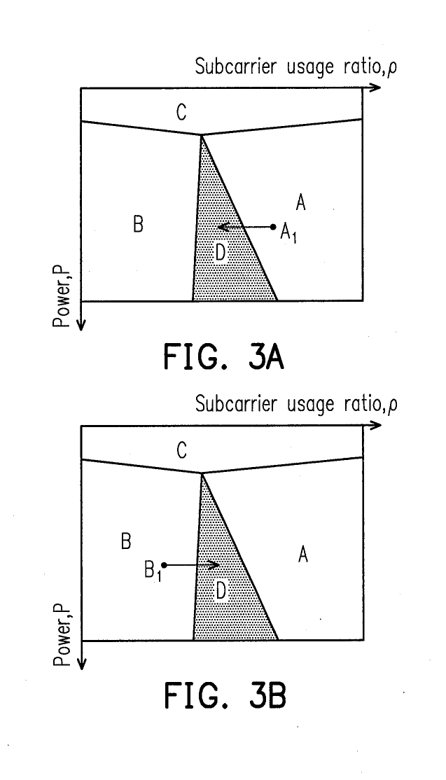

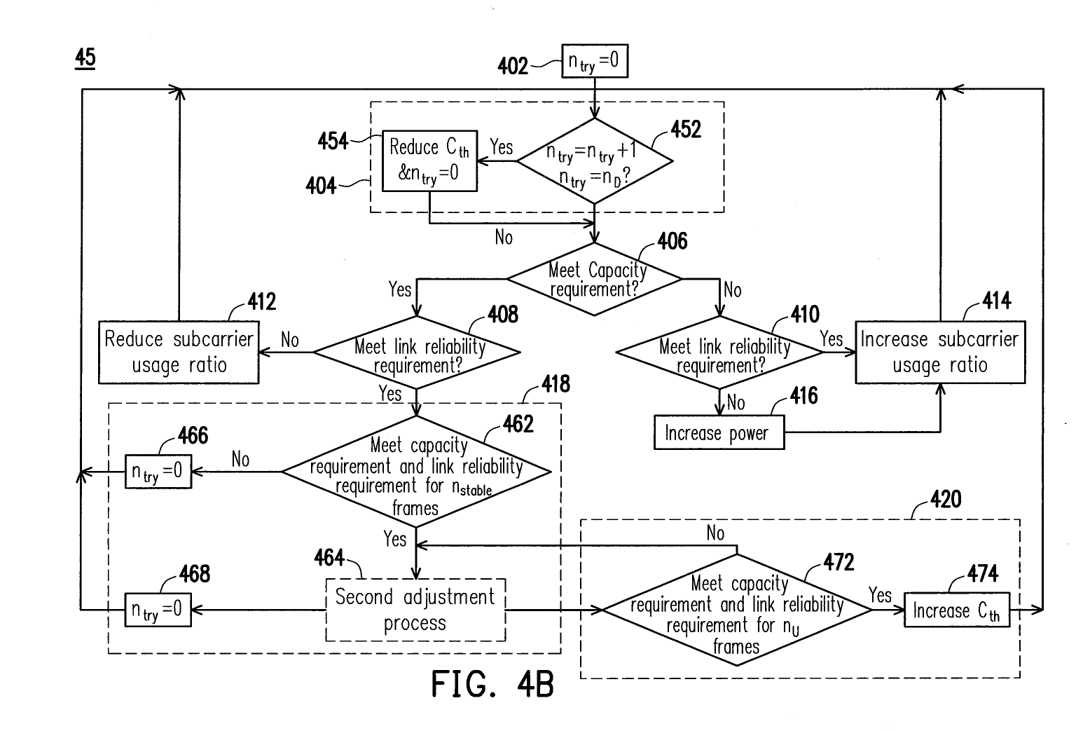

FIG. 3A-FIG. 3D are four schematic diagrams respectively illustrating top views of FIG. 2 under different powers and subcarrier usage ratios. The two dimensional parameters of FIG. 3A-FIG. 3D are the power, P and the subcarrier usage ratio, ρ. For the simplicity of illustration, the examples shown in FIG. 3A-FIG. 3D just illustrate four areas A, B, C and D, which are possibly appeared. The area D corresponds to the top view projection area of the portion similar to the triangular pyramid shown in FIG. 2. That is, the area D is a feasible solution area, and areas other than the area D are not feasible solution areas. The vertex V shown in FIG. 3D then refers to the parameter set of the power and the subcarrier usage ratio when the maximal power efficiency is achieved. The area A refers to the parameter set of the power and the subcarrier usage ratio which meets the capacity requirement but does not meet the link reliability requirement; the area B refers to the power and the subcarrier usage ratio combination which meets link reliability requirement but does not meet the capacity requirement; the area C refers to the power and the subcarrier usage ratio combination which does not meet both the capacity requirement and the link reliability requirement. Possible approaches of the joint subcarrier usage ratio and power allocation method are briefly described in accordance with FIG. 3A to FIG. 3C, where the possible approaches could make the parameter set of the power and the subcarrier usage ratio falls within the feasible solution area. The principle of the fine adjustment process shown in FIG. 5 will also be described along with FIG. 3D.

In FIG. 3A, the initial parameter set of the power and the subcarrier usage ratio falls within the area A. Since it is not within the feasible solution area, a feasible solution could be obtained if the power and the subcarrier usage are adjusted in a direction towards the area D. For example, with the initial parameter set A₁, a feasible solution could be obtained by reducing the subcarrier usage ratio.

In FIG. 3B, the initial parameter set of the power and the subcarrier usage ratio falls within the area B. Since it is not within the feasible solution area, a feasible solution could be obtained if the power and the subcarrier usage are adjusted in a direction towards the area D. For example, with the initial parameter set B₁, a feasible solution could be obtained by increasing the subcarrier usage ratio.

In FIG. 3C, the initial parameter set of the power and the subcarrier usage ratio falls within the area C. Since it is not within the feasible solution area, a feasible solution could be obtained if the power and the subcarrier usage are adjusted in a direction towards the area D. How to find the feasible solution is relatively complicated, if the initial parameter set falls within the area C. For example, the parameter set C₁ or C₂ could be adjusted by first increasing the power in order to enter the area B, and further increasing the subcarrier usage ratio so as to obtain the feasible solution. For another example, to obtain a feasible solution, the parameter set C₃ could be adjusted by first increasing the power in order to enter the area A, and further reducing the subcarrier usage ratio so as to obtain the feasible solution. In FIG. 3D, the parameter set D₁ is the power and the subcarrier usage ratio combination belonging to feasible solution area.

In the present disclosure, the feasible solution of power and subcarrier usage ratio should be selected, aiming at maximizing the power efficiency as the following mathematical expression (1):

$${max}_{0 \leq ρ \leq 1 , P min \leq {P}_{j} \leq P max} \frac{{\sum }_{j = 1}^{J} {ɛ}_{j} {B}_{j} {σ}_{j}}{{\sum }_{j = 1}^{J} {ɛ}_{j} {p}_{j}} , \qquad expression ( 1 )$$

subject to:

$$\begin{matrix}{\sum }_{j = 1}^{J} {ɛ}_{j} {B}_{j} {σ}_{j} \geq {C}_{th} , & expression ( 2 ) \\ \overline{{P}_{rel}} \geq {Rel}_{th} , & expression ( 3 ) \\ \begin{matrix}ρ = \frac{1}{J} {\sum }_{j = 1}^{J} {ɛ}_{j} , & \begin{matrix}{ɛ}_{j} ∈ \{ 0 , 1 \} , & ∀ j\end{matrix}\end{matrix} . & expression ( 4 )\end{matrix}$$

In the mathematical expression (1), the power efficiency is defined as the ratio of the achieved capacity (throughput) of one femtocell to the total power of one femtocell for transmission. εⱼ denotes whether the j^{th} subcarrier (subchannel) is currently used for transmission If the j^{th} subcarrier is used then εⱼ=1, and if the j^{th} subcarrier is not used, then εⱼ=0. In the mathematical expression (1), Bⱼ denotes the bandwidth of the j^{th} subcarrier (subchannel). In the mathematical expression (1), σⱼ denotes the spectral efficiency of the j^{th} (subchannel). In the mathematical expression (1), ρ denotes subcarrier usage ratio of the femtocell. In the mathematical expression (1), pⱼ denotes the power of the j^{th} subcarrier (subchannel). As defined in the mathematical expression (4), the subcarrier (subchannel) usage ratio ρ is the total number of OFDMA subcarriers (subchannels) currently used by the femtocell divided by the total number J of usable OFDMA subcarriers (subchannels). In other words, the subcarrier (subchannel) usage ratio is a ratio of the number of the total number of OFDMA subcarriers (subchannels) currently used by the femtocell to the total number J of usable OFDMA subcarriers (subchannels).

In the mathematical expression (2), Cₜₕ denotes a lower threshold of capacity. In the mathematical expression (3), Relₜₕ denotes a lower threshold of link reliability. From other perspectives, the Cₜₕ represents the capacity requirement and the Relₜₕ represents the link reliability requirement.

In the disclosure, the calculation approach of the capacity is not limited thereto, and the capacity could also be calculated by other approaches based on the bandwidth of the subcarriers and the subcarrier usage ratio. The link reliability P̅ᵣ̅ₑ̅ₗ̅ could be calculated according to the following mathematical expression (5):

P̅ᵣ̅ₑ̅ₗ̅=Pᵣ[γ_{eff}≧γₜₕ] expression (5).

In the mathematical expression (5), link reliability P̅ᵣ̅ₑ̅ₗ̅ in fact is a link reliability probability function, which is defined as a probability where the effective carrier-to-interference-and-noise ratio (CINR) γ_{eff} is greater than or equal to the lowest effective CINR γₜₕ, which could be treated as a CINR threshold. The lowest effective CINR value is, for example, −2.5 dB. In the disclosure, the calculation approach of the link reliability is not limited thereto, and the link reliability could also be calculated by other approaches, for example, an approach based on power and signal-to-noise ratio (SNR).

In the present disclosure, for inter-heterogeneous interference between the first type base stations (the femtocells) and the second type base stations (the large cells), an adaptive adjustment process is proposed for adjusting the power and the bandwidth of the femtocell, such that the femtocell could select appropriate power and adequate bandwidth (corresponding to subcarrier usage ratio) to meet the capacity requirement and link reliability requirement. In general, the joint subcarrier usage ratio and power allocation method could be divided into two major steps. The first step is a first adjustment process (could also be seen as a coarse adjustment process), aiming to quickly find a feasible parameter set of power and subcarrier usage ratio, and such a parameter set could ensure the transmission quality and the required capacity of the users. The second step is a second adjustment process (could also be seen as a fine adjustment process), aiming to find a feasible parameter set of power and subcarrier usage ratio to maximize the power efficiency. The second step mainly tests whether the current requirements of the users could still be met (or satisfied) by using less wireless communication resource (corresponding to subcarrier usage ratio) or power.

In the disclosure, the general principle of the joint subcarrier usage ratio and power allocation method is first to acquire initial values of power and subcarrier usage ratio (subchannel usage ratio) and then to make adjustments on the acquired initial values according to the achieved capacity and the link reliability in the first step. The cellular system could estimate the deployment density of femtocell within the coverage thereof, computes a parameter set mapping table by off-line simulation, and regularly broadcasts the parameter set mapping table to the corresponding femtocells via the fixed residential broadband networks. Then, after looking up the parameter set mapping table, the femtocell acquires the initial values of power and subcarrier usage ratio. Then, the adjustment approach could be selected according to the following four conditions. The first condition is that the capacity is not sufficient and the link reliability (channel quality) is not good, so what the adjustment approach should be adopted in response to the first condition is to increase both the power and the subcarrier usage ratio (subchannel usage ratio). The second condition is that the capacity is not sufficient but the link reliability (or channel quality) is good, so what the adjustment approach should be adopted in response to the second condition is to just increase the subcarrier usage ratio (subchannel usage ratio).

The third condition is that the capacity is sufficient but the link reliability (channel quality) is not good, so what the adjustment approach should be adopted in response to the third condition is to just reduce the subcarrier usage ratio (subchannel usage ratio). The fourth condition is that the capacity is sufficient and the link reliability (channel quality) is good, so the power and the subcarrier usage ratio are within the feasible solution area. In the fourth condition, the second step could be executed to test whether lower subcarrier usage ratio (subchannel usage ratio) or less power could meet the requirements of the users. By the second step, the joint subcarrier usage ratio and power allocation approach could find the optimal combination of subcarrier usage ratio and power to maximize the power efficiency.

In the second step, if less power or lower subcarrier usage ratio (subchannel usage ratio) is selected and the requirements of capacity and link reliability are still met, then the adjusted power or subcarrier usage ratio (subchannel usage ratio) is maintained. On the contrary, if the requirements of capacity and link reliability cannot be met by using the original combination of power and subcarrier usage ratio obtained by the first step or by using less power or lower subcarrier usage ratio (subchannel usage ratio) after several frames, then it is required to return to execute the first step. The main reasons for returning to the first step could be: firstly, when the aforementioned test in the second step fails, it represents that the power or subcarrier usage ratio (subchannel usage ratio) might be situated at inappropriate operation point, so it is required to return to the first step for re-seaching a feasible solution; secondly, when the usage conditions of surrounding base stations are changed or the radio channel conditions of the users are changed, the optimal operation point are changed accordingly, so the femtocell should adjust power or subcarrier usage ratio (subchannel usage ratio) according to such changes in surrounding environment conditions.

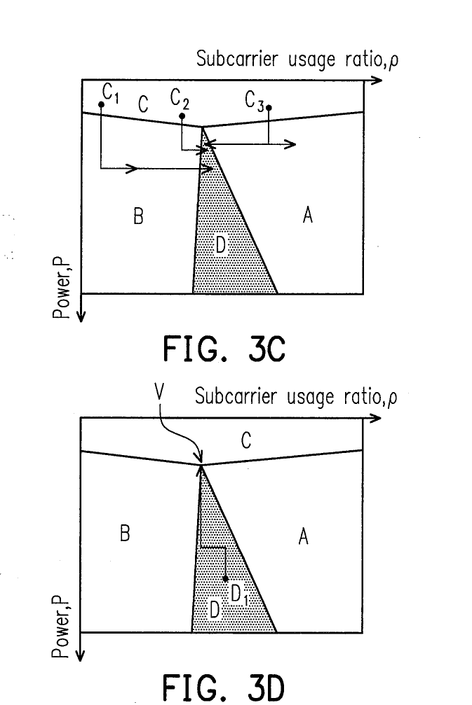

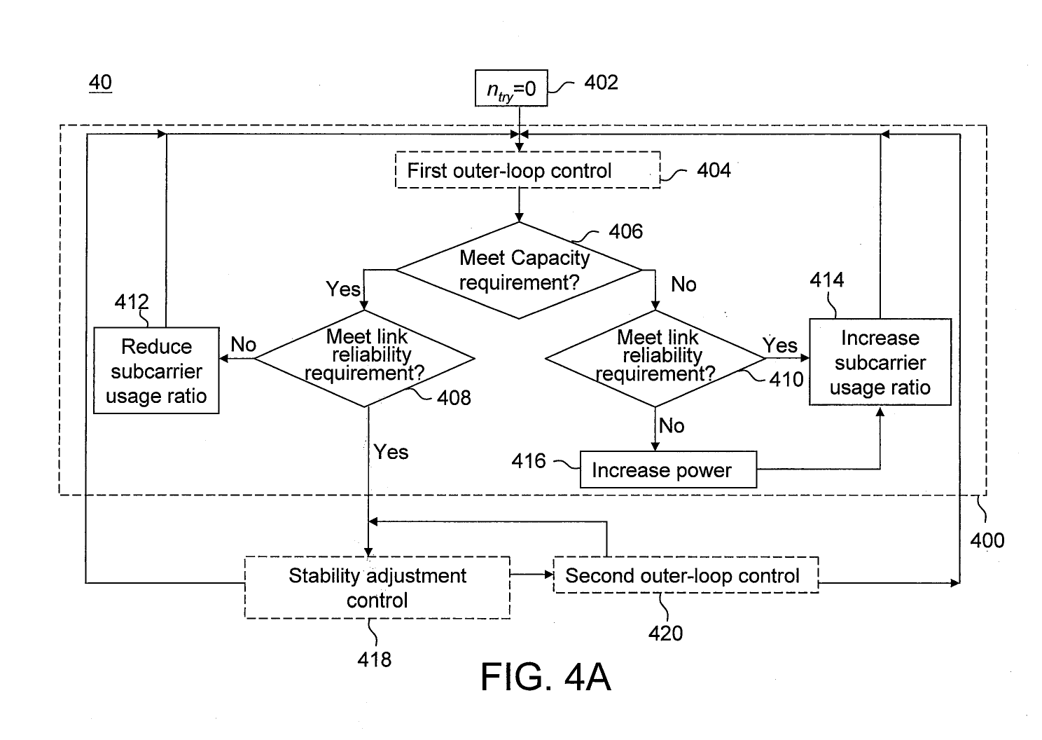

According to flowcharts (for the process of allocating subcarriers and power control) illustrated in FIG. 4A, FIG. 4B, and FIG. 5, a parameter set of power and subcarrier usage ratio could be adjusted for achieving the maximal power efficiency under the capacity requirement and link reliability requirement. The first step (that is, the first adjustment process) is described in FIG. 4A or FIG. 4B. The second step (that is, the second adjustment process) is detailed in FIG. 5.

FIG. 4A is a flowchart illustrating a joint subcarrier usage ratio and power allocation method 40 according to an exemplary embodiment. In FIG. 4A, the method 40 mainly includes a first adjustment process 400, a stability adjustment control step 418 and the first outer-loop control step 404 and the second outer-loop control step 420. The stability adjustment control step 418 and the outer-loop control step 404 and step 420 will be further described in details in accordance with FIG. 4B. The first adjustment process 400 basically summarizes the approaches described previously for adjusting the power and the subcarrier usage ratio in accordance with FIG. 3A to FIG. 3C, and thus provides a fast selection method for the power and the subcarrier usage ratio to find a feasible solution. The method 40 starts at a step 402, which initializes an attempt count value n_{try} to be 0. The detailed procedures of the first adjustment process 400 are from step 404 to step 416.

Referring to FIG. 4A, in the present exemplary embodiment, the step 404 is a first outer-loop control step. It mainly tests whether the attempt count value n_{try} has reached an upper threshold for relaxing the capacity requirement in the step 404. The detailed technical procedures will be described in detail in accordance with FIG. 4B. However, in the present exemplary embodiment, the step 404 is not a necessary step in the first adjustment process 400, and a step 406 could be directly executed straight after the step 402 in some situations. In the step 406, it is to check whether the capacity requirement is met. Here, checking whether the capacity requirement is met is to determine whether the current capacity is greater than or equal to the capacity threshold. If yes, then a step 408 is executed after the step 406; if not, then a step 410 is executed after the step 406.

In the step 408, it checks whether the link reliability requirement is met. Here, checking whether the link reliability requirement is met is to determine whether the current link reliability is greater than or equal to the link reliability threshold. If yes, then the step 418 is executed after the step 408, so as to execute the stability adjustment control step (including the second adjustment process 464); if not, then step 412 is executed after the step 408 for reducing the subcarrier usage ratio. It is to return to execute the step 404 or the step 406 after the step 412.

In comparison with the step 408, it also checks whether link reliability requirement is met in the step 410. If yes, then a step 414 is executed after the step 410 for increasing the subcarrier usage ratio; if not, a step 416 is executed after the step 410 for increasing the power. It is to also execute the step 414 after the step 416 for increasing the subcarrier usage ratio. It is to return to execute the step 404 or the step 406 after the step 414. After the step 418, a second outer-loop control step 420 could be selected for execution, or it could return to the step 404 or the step 406. Similarly, after the step 420, the stability control step 418 could be selected for execution, or it could return to the step 404 or the step 406. However, the stability control step 418 and the second outer-loop control step 420 are not necessary procedures of the method 40. That is, if the check result is yes in the step 408, then it could directly return to execute the step 404 or the step 406.

FIG. 4B is a flowchart illustrating another joint subcarrier usage ratio and power allocation method 45 according to another exemplary embodiment. The method 45 further describes detailed technical procedures of the step 404, the step 418 and step 420 which might be executed in the method 40 of FIG. 4A. In the present exemplary embodiment of FIG. 4B, the step 404 includes a step 452 and a step 454; the step 418 includes a step 462 to a step 468; the step 420 includes a step 472 and a step 474.

The method 45 starts at step 402, and continues to execute the step 452, which increases the attempt count value n_{try} by one count unit, and further checks whether the attempt count value n_{try} is equal to a down threshold n_{D}. If yes, then the step 454 is executed after the step 452 for reducing the capacity threshold Cₜₕ by one unit, and initializes an attempt count value n_{try} to be 0 again; if not, the step 406 is executed after the step 452. It is also to execute the step 406 after the step 454.

The first outer-loop control step 404 in FIG. 4B is symmetrical to the second outer-loop control step 420, which mainly increases the capacity threshold Cₜₕ by one unit when both the requirements of capacity and link reliability are met for an up threshold n_{U} frames. The main reason for reducing the capacity threshold in the first outer-loop control step 404 lies in the fact that the current power or subcarrier usage ratio (subchannel usage ratio) allocation might be situated at inappropriate operation point. Therefore, if the method still cannot find a feasible solution after n_{D} tries (n_{D} frames), the method should relax the capacity requirement to enlarge the feasible solution area. The main reason for increasing the capacity threshold in the second outer-loop control step 420 are due to the facts that the interference from macrocell and other femtocells is reduced or the desired signal strength is improved. For example, the usage conditions of surrounding base stations might be reduced, or the radio channel conditions of the users become better. Therefore, if both the capacity requirement and link reliability requirement could be met for consecutive n_{U} frames, the joint subcarrier usage ratio and power allocation method will increase the capacity threshold and thus the users could have higher data rate. If the capacity threshold Cₜₕ is configured as 5 Mbps, then the unit (or step size) by which the capacity threshold Cₜₕ is increased or reduced could be, for example, 5 Mbps×10%=500 Kbps. Also, the up threshold n_{U} should be configured to be less than the down threshold n_{D} such that the method 45 reduces the capacity threshold Cₜₕ more quickly but increases the capacity threshold Cₜₕ more slowly. Quick reduction of the capacity threshold Cₜₕ could help quickly acquire a feasible solution of power and subcarrier usage ratio. Slow increase of the capacity threshold Cₜₕ could ensure the stability of the whole femtocell system. Since the step 406 to the step 416 have been described in FIG. 4A, the technical procedures thereof are not repeated here.

Referring to FIG. 4B, if the check result in the step 408 is yes, then a step 462 is executed after the step 408, for checking whether the requirements of the capacity and the link reliability are consecutively met for a stability threshold n_{stable} frames. If yes, the second adjustment process step 464 is then executed after the step 462 such that the power and the subcarrier usage ratio are slowly adjusted in feasible solution area until the maximal power efficiency condition is achieved; if not, then step 466 is executed after the step 462 so as to re-initialize the attempt count value n_{try} to be 0. The more detailed technical procedures of the second adjustment process step 464 will be further described in accordance with FIG. 5. The step 468 or the step 472 is selected to be executed after the step 464.

In the step 468, it re-initializes the attempt count value n_{try} to be 0. The step 452 is executed after the step 466 and the step 468. In the step 472, it is to check whether the requirements of both the capacity and the link reliability are met for the up threshold n_{U} frames. If yes, the step 474 is executed after the step 472 for increasing the capacity threshold Cₜₕ by one unit; if not, it is to return to execute the step 464 after the step 472. The down threshold n_{D} is, for example, 2 frames; the up threshold n_{U} is, for example, 10 frames; the stability threshold n_{stable} is, for example, 20 frames; the capacity threshold Cₜₕ is, for example, 5 Mbps; the link reliability threshold Relₜₕ is, for example, 0.9. However, the disclosure is not limited thereto, and each threshold value could be adjusted or selected according to wireless communication system parameters and charging (subscription) plan of the users.

FIG. 5 is a flowchart illustrating the fine adjustment process as illustrated in FIG. 4. The general principle of the second adjustment process 464 is described as the following. After the feasible parameter set D₁ of the tested power and the tested subcarrier usage ratio is selected in the step 408, the surrounding parameters in the area D are continued to be tested, as the approach adopted in FIG. 3D. In FIG. 3D, the power and subcarrier usage ratio are gradually and slowly adjusted from the parameter set D₁ towards the vertex V, which represents the maximal power efficiency condition.

In principle, the step 464 is executed after the step 408, or after the step 472, and the step 464 includes the step 502 to the step 518. Also, the step 472 is executed from the step 464 via the step 506, the step 510, the step 514, or the step 516; and the step 400 is executed from the step 464 via the step 518 and the step 468. In the step 502, the current power pᵢ and subcarrier usage ratio ρᵢ are first recorded, where the index i represents the power and subcarrier usage ratio are now at the level i. The index i+1 represents that the power is increased by one unit, or the subcarrier usage ratio is increased by one unit. The index i−1 represents that the power is decreased by one unit, or the subcarrier usage ratio is decreased by one unit. In the following steps 504, 508, 512 and 516, the surrounding parameters of the power pᵢ and subcarrier usage ratio ρᵢ are respectively selected and tested. By doing so, the method could determine whether less power or lower subcarrier usage ratio could be used for maximizing the power efficiency under the requirements of the capacity and the link reliability.

Referring to FIG. 5, in the step 504, it is to test whether the requirements of the capacity and the link reliability are met by using the power pᵢ and the subcarrier usage ratio ρᵢ₋₁, where the subcarrier usage ratio ρᵢ₋₁ represents the subcarrier usage ratio value less than the current subcarrier usage ratio ρᵢ by one unit, and the unit (or the step size) of the subcarrier usage ratio is, for example, 0.1. If the test is passed, then the step 506 is executed after the step 504, so as to change current subcarrier usage ratio ρᵢ to be subcarrier usage ratio ρᵢ₋₁; if the test is failed, then the step 508 is executed after the step 504.

In the step 508, it tests whether the requirements of the capacity and the link reliability are met by using the power pᵢ₋₁ and the subcarrier usage ratio ρᵢ, where the power pᵢ₋₁ represents the power value less than the current power pᵢ by one unit, and the unit (or the step size) of the power is, for example, 1 dBm. If the test is passed, then the step 510 is executed after the step 508, so as to change current power pᵢ to be power pᵢ₋₁; if the test is failed, then the step 512 is executed after the step 508.

In the step 512, it tests whether the requirements of the capacity and the link reliability are met by using the power pᵢ₋₁ and the subcarrier usage ratio ρᵢ₊₁, where the power pᵢ₋₁ represents the power value less than the current power pᵢ by one unit, and the subcarrier usage ratio ρᵢ₊₁ represents the subcarrier usage ratio value greater than the current subcarrier usage ratio ρᵢ by one unit. If the test is passed, then the step 514 is executed after the step 512, so as to change current subcarrier usage ratio ρᵢ to be subcarrier usage ratio ρᵢ₊₁, and change current power pᵢ to be power pᵢ₋₁; if the test is failed, then the step 516 is executed after the step 512. It is to continue executing the step 472 of the step 420 after the step 506, the step 510 and the step 514. The detailed technical procedures of the step 472 to the step 474 are not repeated here since they are described in FIG. 4B. It is returned to execute the step 502 after the step 474.

In the step 516, it tests whether the requirements of the capacity and the link reliability are met by using the original power pᵢ and the original subcarrier usage ratio ρᵢ. If the test is passed, then the step 472 is executed after the step 516; if the test is failed, then the step 518 is executed after the step 516. In the step 518, it checks if the test is consecutively failed for the down threshold n_{D} frames. If yes, then the step 468 is continued to be executed after the step 518; if not, then the step 502 is returned to be executed after the step 502.

According to the large cell base station 10 and the deployment pattern of the femtocells covered by the large cell base station 10 in FIG. 1, simulation results shown in the following two tables could be obtained by selecting appropriate fixed parameters, such as the down threshold nₚ, the up threshold n_{U}, the stability threshold n_{stable}, the capacity threshold Cₜₕ, and the link reliability threshold Relₜₕ, the total number of surrounding femtocells, and the spacing d_{sf} between femtocells. The simulation results shown in Table I are the number of times of adjustments, and there are four main situations considered, such as the case just considering marcocell interference, considering two-tier interference, just considering a single femtocell, and just considering the interference from neighboring femtocells, and so forth.

TABLE I

| | Times of adjustments | |
|---|---|---|
| | Adjusting subcarrier | Adjusting power |
| | usage ratio first | ratio first |
| Macrocell interference only | 8.21 | 9.83 |
| Two-tier interference | 6.71 | 13.78 |
| Only one femtocell | 9.73 | 10.83 |
| Femtocell interference only | 8.65 | 14.72 |
| Average | 8.325 | 12.29 |

Moreover, in Table I, if the subcarrier usage ratio is adjusted first, then the required number of times of adjustments (i.e., joint adjustment of power and subcarrier usage ratio in order to achieve the maximal power efficiency) is apparently less than the case if the power is adjusted first. For example, the average times of adjustments for the case if the power is adjusted first is 12.29, and the average times of adjustments for the case if the subcarrier usage ratio is adjusted first is reduced to 8.325.

The simulation results shown in the Table II are power efficiency (the unit is bits/second/milliwatt), and there are four main situations considered, such as the case just considering marcocell interference, considering two-tier interference, just considering a single femtocell, and just considering the interference from neighboring femtocells, and so forth.

TABLE II

| | Power efficiency | |
|---|---|---|
| | (bits/second/milliwatt) | |
| | The proposed method | Random allocation |
| Macrocell interference only | 1.07 | 0.38 |
| Two-tier interference | 0.83 | 0.24 |
| Only one femtocell | 0.28 | 0.11 |
| Femtocell interference only | 1.78 | 0.63 |
| Average | 0.99 | 0.34 |

Referring to Table II, under each one of the situations being considered, the power efficiency of the proposed joint subcarrier usage ratio and power allocation method is higher than that of the random allocation approach. For example, the average power efficiency of the four main situations achieved by the joint subcarrier usage ratio and power allocation method is 0.99, which is almost three times of the average power efficiency (i.e., 0.34) achieved by the random allocation.

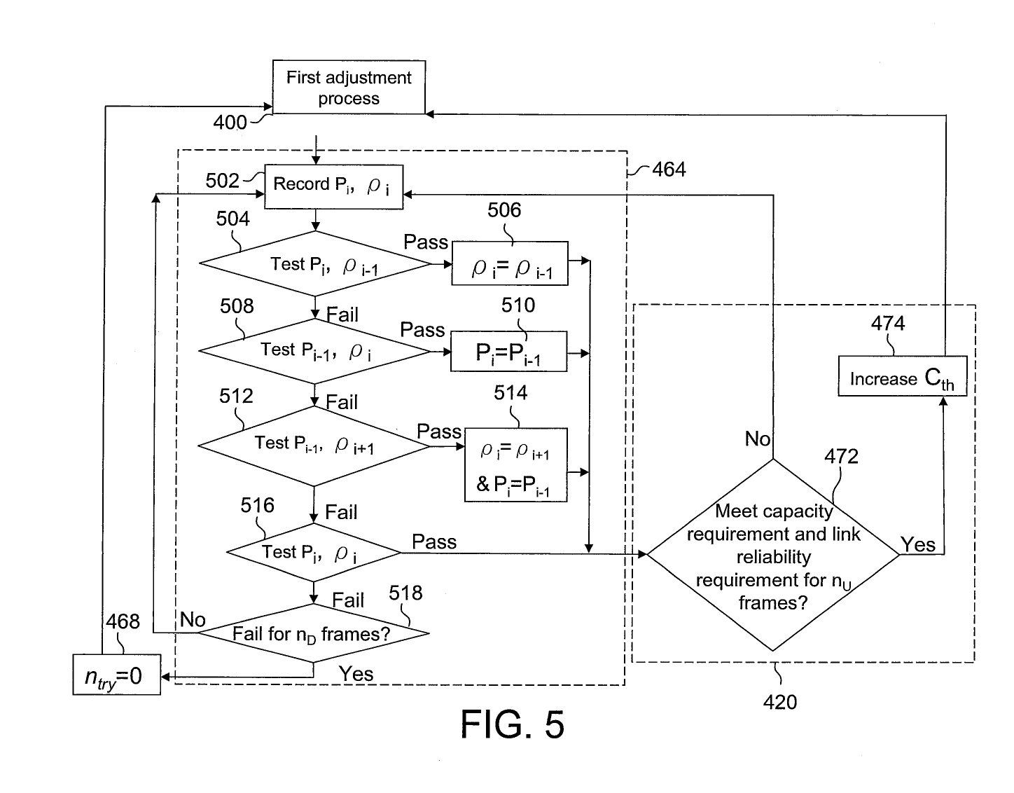

FIG. 6 is a functional block diagram illustrating a femtocell base station 60 according to an exemplary embodiment. The femtocell base station 60 includes at least a transceiver module 61, a protocol module 62, a processor module 63 and a memory module 64. The transceiver module 61 is coupled to an antenna module (not shown) of the femtocell base station 60 and is configured for transmitting radio frequency (RF) signal and receiving RF signal. The protocol module 62 is coupled to the transceiver module 61 and is configured for receiving the data signals received by the transceiver module 61 and transmitting data signals to the transceiver module 61. Moreover, the protocol module 62 also provides control signals to the transceiver module 61 for adjusting power and subcarrier usage ratio. The processor module 63 is coupled to the transceiver module 61, the protocol module 62 and the memory module 64. The processor module 63 is configured for collaborating and managing the transceiver module 61, the protocol module 62 and the memory module 64. The memory module 64 is configured for receiving and storing wireless communication network system parameters provided by the protocol module 62.

Referring to FIG. 6, the protocol module 62 further includes a calculation unit 622, a comparison unit 624, a counter 626, and an adjustment unit 628. In other exemplary embodiments, the protocol module 62 could be also included in the memory module 64, and is configured to be executed by the processor module 63. The calculation unit 622, the comparison unit 624, the counter 626, and the adjustment unit 628 are coupled together.

The calculation unit 622 is configured for calculating subcarrier usage ratio and link reliability. The comparison unit 624 could execute the comparison or checking process of the steps 406, 408, 410 in FIG. 4A. Similarly, the comparison unit 624 could also execute comparison or checking process of the steps 452, 462, 472 in FIG. 4B, and execute comparison process or testing process of the steps 504, 508, 512, 516, 518 in FIG. 5. As illustrated in a simple manner, the comparison unit 624 compares or determines whether the current capacity of the femtocell base station 60 is greater than or equal to the capacity threshold Cₜₕ, and also compares or determines whether the current link reliability of the femtocell base station 60 is greater than or equal to the link reliability threshold Relₜₕ.

The counter 626 is configured for executing adjustment process, accumulation process or initialization process of the steps 402, 452, 454, 466, 468, 472 in FIG. 4B, and accumulation of a fail counter for the step 518 in FIG. 5. The adjustment unit 628 is configured for executing the steps 412, 414, 416, 454, 474 in FIG. 4B and executing the steps 506, 510, 514 in FIG. 5.

The down threshold n_{D}, the up threshold n_{U}, the stability threshold n_{stable}, the capacity threshold Cₜₕ, and the link reliability threshold Relₜₕ described in FIG. 4B could be provided by a controller through the fixed residential broadband network to the femtocell base station 60, and these threshold parameters could be further stored in the memory module 64. In other exemplary embodiments, the capacity threshold Cₜₕ, and the link reliability threshold Relₜₕ might be also configured by the one who deploys the femtocell base station 60.

Furthermore, since the controller could practically calculate or estimate the deployment density of the femtocells in the coverage area of the large cell base station 10, and the feasible solutions for each of various deployment densities could be obtained in advance by off-line simulations. Therefore, in the present disclosure, the controller could store the deployment density of the femtocells and the parameter sets of the corresponding feasible solutions in a parameter set mapping table. Then, the parameter set mapping table and the current deployment density of femtocells could be periodically broadcast by the controller to all femtocell base stations through the fixed residential broadband network or broadcast to all femtocell base stations wirelessly. Accordingly, the dynamic adjusting subcarrier usage ratio and power of the femtocells could be made more efficient.

In an exemplary embodiment of the disclosure, several base stations similar to the large cell base station 10, several femtocell base stations similar to the femtocell base station 60, and a core network could form a wireless communication system. In the wireless communication system, a controller could periodically broadcast the femtocell deployment density and the parameter set mapping table. Each of the femtocall base stations then operates in a distributed manner for selecting the adequate parameter set of subcarrier usage ratio and power according to the joint subcarrier usage ratio and power allocation method 40, 45 and the second adjustment step 464, such that the maximal power efficiency of each of the femtocell base stations could be achieved.

The functionality of the controller in the joint subcarrier usage ratio and power allocation method could be detailed in the following disclosure. In an exemplary embodiment of the disclosure, the core network could include the controller, which is configured to manage the femtocell base stations or provide necessary information for the joint subcarrier usage ratio and power allocation method to the femtocell base stations. The controller is also called an operator network controller, which might be a centralized control center for managing the femtocell base stations in the wireless communication system. However, the present disclosure is not limited thereto, and in other embodiments of the disclosure, the controller could also include a large cell base station, or could be integrated with a large cell base station.

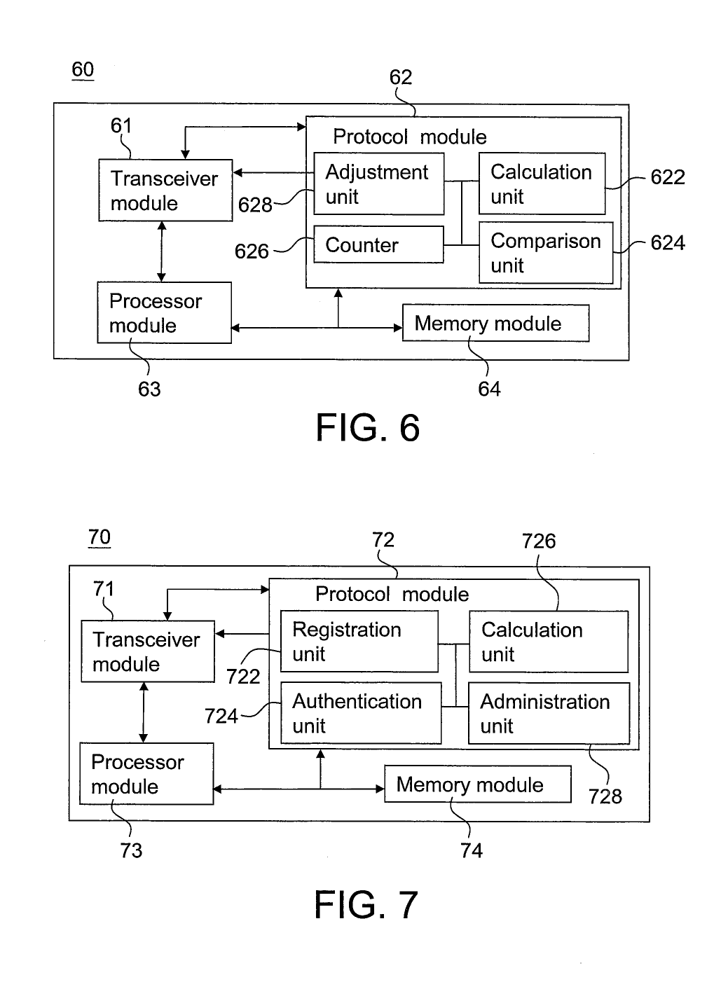

FIG. 7 is a functional block diagram illustrating a controller 70 according to an exemplary embodiment. Referring to FIG. 7, the controller 70 includes at least a transceiver interface 71, a protocol module 72, a processor module 73 and a memory module 74. The transceiver interface 71 is coupled to a fixed residential broadband network for transmitting data or receiving data. The protocol module 72 is coupled to the transceiver interface 71 and is configured for performing registration, authentication, calculation and administration procedures associated with the femtocell base stations in the wireless communication system.

The processor module 73 is coupled to the transceiver interface 71, the protocol module 72 and the memory module 74. The processor module 73 is configured for collaborating and managing the transceiver interface 71, the protocol module 72 and the memory module 74. The memory module 74 includes at least a database (not shown in FIG. 7).

Referring to FIG. 7, the protocol module 72 further includes a registration unit 722, an authentication unit 724, a calculation unit 726, and an administration unit 728. In other exemplary embodiments, the protocol module 72 could be also included in the memory module 74, and is configured to be executed by the processor module 73. The registration unit 722, an authentication unit 724, a calculation unit 726, and an administration unit 728 are coupled together.

The registration unit 722 is configured for performing registration procedures of any one of the femtocell base stations after the femtocell base station initiates the registration procedures. The authentication unit 722 is configured for performing authentication procedures of any one of the femtocell base stations after the femtocell base station initiates the authentication procedures. The registration unit 722 records the femtocell base stations along with their respective geographical location, address, and device identifier (such as Medium Access Control layer address) in the database of the memory module 74.

The calculation unit 726 obtains feasible solutions for each one of femtocell deployment densities by off-line simulations, and estimates femtocell deployment density in a coverage area of a large cell base station, where a femtocell base station or a plurality of femtocell base stations are within the coverage area of the large cell base station. The calculation unit 726 stores the deployment density of the femtocell base stations and the parameter sets of the corresponding feasible solutions in a parameter set mapping table. The parameter set mapping table is stored in the database of the memory module 74.

In the present exemplary embodiments, the administration unit 728 could provide the parameter set mapping table and the femtocell deployment density to the femtocell base stations through the fixed network such that the femtocell base station could acquire initial values of power and subcarrier usage ratio according to the femtocell deployment density. In other words, the femtocell base station could acquire the initial values of power and subcarrier usage ratio according to the currently registered first type base stations. Also, in other embodiments of the disclosure, the administration unit 728 could configure capacity threshold Cₜₕ of each of the femtocell base stations. Moreover, the administration unit 728 could also broadcast the parameter set mapping table and the femtocell deployment density to the femtocell base stations wirelessly. In addition, the administration unit 728 of the controller 70 could command each one of the femtocell stations to lower or increase their respective capacity threshold Cₜₕ.

When any one of the femtocell base stations in the wireless communication system is switched on, the femtocell base station is required to perform a registration procedure and an authentication procedure with the controller 70 of the core network. Thereby, the controller 70 could estimate the femtocell density in a serving area of any macro cell base station, any micro cell base station or any large cell base station used in the present disclosure.

The controller 70 also performs the off-line simulation, and obtains the parameter set mapping table. The administration module 728 of the controller 70 could periodically or regularly broadcast the femtocell deployment density and the parameter set mapping table to the femtocell base stations through the fixed residential broadband network. Alternatively, the controller 70 can multicast or unicast the femtocell density and the parameter set mapping table to the required femtocell base station(s) through the fixed residential broadband network. In addition, the controller 70 configures a throughput upper threshold, such that power of the femtocell base stations is limited.

Moreover, any one of the large cell base stations (including macro cell base stations, micro cell base stations, or pico cell base stations) in the wireless communication system could report to the controller 70 that the reporting large cell base station is currently experiencing too strong interference from femtocell stations in its own current serving area or from neighboring femtocell stations. In response to the report from the large cell base station, the administration unit 728 of the controller 70 could command the related femtocell stations to lower their respective capacity threshold Cₜₕ, such that the overall interference experienced the reporting large cell base station is reduced.

In other exemplary embodiment, the controller 70 of the core network could be integrated with register servers of the wireless communication system, such as Home Location Register (HLR) or Authentication Center (AUC) in 3GPP LTE system.

In summary, according to the exemplary embodiments of the disclosure, a joint subcarrier usage ratio and power allocation method, a wireless communication system using the same, a base station and a controller using the same are proposed. By jointly and dynamically adjusting the subcarrier usage ratio and power, both the capacity requirement and the link liability requirement could be met. Also, a first adjustment process is used to quickly obtain a feasible solution of parameter set, symmetric outer-loop control processes are used to increase or reduce the capacity threshold, and a second adjustment process is used to slowly adjust the power and subcarrier usage ratio so as to achieve the maximal power efficiency. In addition, the proposed joint subcarrier usage ratio and power allocation method requires less times of adjustments and is more effective when the subcarrier usage ratio is adjusted earlier than the power is adjusted.

It will be apparent to those skilled in the art that various modifications and variations could be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A joint subcarrier usage ratio and power allocation method, adapted for a base station using OFDMA technology to select the power and the subcarrier usage ratio, the method comprising:
a first adjustment process, wherein the first adjustment process simultaneously, dynamically and jointly adjusts the power and the subcarrier usage ratio, so as to meet the predetermined capacity requirement and link reliability requirement.

2. The method according to claim 1 further comprising:
a first outer-loop control process, wherein the first outer-loop control process lowers a capacity threshold of the capacity requirement by one unit and initializes an attempt count value to be 0, when the attempt count value being accumulated in the first adjustment process is greater than a down threshold.

3. The method according to claim 1 further comprising:
a second adjustment process, wherein the second adjustment process slowly reduces the power or adjusts the subcarrier usage ratio for achieving a maximal power efficiency after the duration for which both the capacity requirement and the link reliability requirement are continuously met under the power and the subcarrier usage ratio being adjusted by the first adjustment process is greater than a stability threshold.

4. The method according to claim 1 further comprising:
a second outer-loop control process, wherein the second outer-loop control process increases the capacity threshold by one unit, when the duration for which both the capacity requirement and the link reliability requirement are continuously met under the power and the subcarrier usage ratio being adjusted by the second adjustment process is greater than an up threshold.

5. The method according to claim 1, wherein the first adjustment process further comprises:
checking whether the capacity requirement and the link reliability requirement are met, and determining to increaser the power or increase or lower the subcarrier usage ratio according to the capacity requirement and the link reliability requirement.

6. The method according to claim 3, wherein the second adjustment process further comprises:
testing whether the capacity requirement and the link reliability requirement are both met if the subcarrier usage ratio is lowered by one unit, wherein if yes, then the subcarrier usage ratio is lowered by one unit;
testing whether the capacity requirement and the link reliability requirement are both met if the power is reduced by one unit, wherein if yes, then the power is reduced by one unit; and
testing whether the capacity requirement and the link reliability requirement are both met if the power is reduced by one unit but the subcarrier usage ratio is increased by one unit, wherein if yes, then the power is reduced by one unit and the subcarrier usage ratio is increased by one unit.

7. The method according to claim 1, wherein a controller within whose coverage area the base station is located provides the link reliability requirement, the capacity requirement, a deployment density and a parameter set mapping table for the base stations, wherein the base station selects the initial values of the power and the subcarrier usage ratio from the parameter set mapping table provided by the controller according to the femtocell deployment density informed by the controller.

8. The method according to claim 1, wherein the subcarrier usage ratio is a ratio of the number of OFDMA subcarriers currently used by the base station to the total number of all usable OFDMA sbucarriers.

9. The method according to claim 1, wherein a link reliability is compared with a link reliability threshold for determining whether the link reliability requirement is met, wherein the link reliability calculated by the base station is defined as a probability of an effective CINR being greater than or equal to a lowest CINR.

10. A joint subcarrier usage ratio and power allocation method, adapted for at least a base station using OFDMA technology within the coverage area of a large cell, the method comprising:
estimating the deployment density of the at least a base station within the coverage area of the large cell; and
computing a parameter set mapping table by off-line simulation; and periodically broadcasting the femtocell deployment density and the parameter set mapping table to the base stations.

11. The method according to claim 10, wherein one of the at least a base station selects the initial power and subcarrier usage ratio from the parameter set mapping table according to the femtocell deployment density, and jointly, simultaneously and dynamically adjusts the power and the subcarrier usage ratio.

12. The method according to claim 11, wherein the subcarrier usage ratio is a ratio of the number of OFDMA subcarriers currently used by the at least a base station to the total number of all usable OFDMA subcarriers.

13. A wireless communication system, comprising:
at least a base station, wherein the at least a base station uses OFDMA technology, and simultaneously, dynamically and jointly adjusts power and a subcarrier usage ratio, so as to meet the predetermined capacity requirement and link reliability requirement.

14. The wireless communication system according to claim 13, wherein the at least a base station lowers a capacity threshold of the capacity requirement by one unit and initializes an attempt count value to be 0, when the attempt count value being accumulated is greater than a down threshold.

15. The wireless communication system according to claim 13, wherein the at least a base station reduces the power or adjusts the subcarrier usage ratio for achieving a maximal power efficiency after the duration for which both the capacity requirement and the link reliability requirement are continuously met under the power and the subcarrier usage ratio being adjusted is greater than a stability threshold.

16. The wireless communication system according to claim 13, wherein the at least a base station increases the capacity threshold by one unit, when the duration for which both the capacity requirement and the link reliability requirement are continuously met under the power and the subcarrier usage ratio being adjusted is greater than an up threshold.

17. The wireless communication system according to claim 13, wherein the at least a base station further checks whether the capacity requirement and the link reliability requirement are met, wherein,
when both the capacity requirement and the link reliability requirement are not met, then the power and the subcarrier usage ratio are both increased;
when the capacity requirement is not met but the link reliability requirement is met, then just the subcarrier usage ratio is increased; and
when the capacity requirement is met but the link reliability requirement is not met, then just the subcarrier usage ratio is lowered.

18. The wireless communication system according to claim 15, wherein,
the at least a base station further tests whether the capacity requirement and the link reliability requirement are both met if the subcarrier usage ratio is lowered by one unit, wherein if yes, then the subcarrier usage ratio is lowered by one unit;
the at least a base station further tests whether the capacity requirement and the link reliability requirement are both met if the power is reduced by one unit, wherein if yes, then the power is reduced by one unit; and
the at least a base station further tests whether the capacity requirement and the link reliability requirement are both met if the power is reduced by one unit but the subcarrier usage ratio is increased by one unit, wherein if yes, then the power is reduced by one unit and the subcarrier usage ratio is increased by one unit.

19. The wireless communication system according to claim 13, wherein a controller within whose coverage area the base station is located provides the link reliability requirement, the capacity requirement, a femtocell deployment density and a parameter set mapping table for the base stations, wherein the base station selects the initial values of the power and the subcarrier usage ratio from the parameter set mapping table according to the femtocell deployment density.

20. The wireless communication system according to claim 13, wherein the subcarrier usage ratio is a ratio of the number of OFDMA subcarriers currently used by the at least a base station to the total number of all usable OFDMA subcarriers.

21. The wireless communication system according to claim 13, wherein a link reliability is compared with a link reliability threshold for determining whether the link reliability requirement is met, wherein the link reliability calculated by the at least a base station is defined as a probability of an effective CINR being greater than or equal to a lowest CINR.

22. A wireless communication system, comprising:
a controller, configured for estimating a deployment density of at least a base station within the coverage area; computing a parameter set mapping table by off-line simulation; and periodically broadcasting the deployment density and the parameter set mapping table to the at least a base station.

23. The wireless communication system according to claim 22, wherein one of the at least a base station selects the initial power and subcarrier usage ratio from the parameter set mapping table according to the deployment density; and jointly, simultaneously and dynamically adjusts power and a subcarrier usage ratio.

24. The wireless communication system according to claim 23, wherein the subcarrier usage ratio is a ratio of the number of OFDMA subcarriers currently used by the at least a base station to the total number of all usable OFDMA subcarriers.

25. A base station, adapted for simultaneously, dynamically and jointly adjusting power and a subcarrier usage ratio, wherein the bases station uses OFDMA technology, the base station comprising:
a calculation unit, configured for calculating link reliability and a subcarrier usage ratio;
an adjustment unit, configured for adjusting power and the subcarrier usage ratio; and
a comparison unit, configured for determining whether the currently capacity of the base station is greater than or equal to a capacity threshold, and determining whether a calculated link reliability is greater than or equal to a link reliability threshold.

26. The base station according to claim 25 further comprising:
a counter, configured for accumulating an attempt count value, wherein when the attempt count value is greater than a down threshold, the adjustment unit lowers the capacity threshold by one unit and the counter initializes the attempt count value to be 0.

27. The base station according to claim 26, wherein the adjustment unit reduces the power or adjusts the subcarrier usage ratio so as to achieve a maximal power efficiency, after an attempt duration is greater than a stability threshold, wherein the attempt duration represents a duration for which the current capacity is continuously greater than or equal to the capacity threshold and the calculated link reliability is continuously greater than or equal to the link reliability threshold.

28. The base station according to claim 27, wherein the adjustment unit increases the capacity threshold by one unit, when an attempt duration is greater than an up threshold.

29. The base station according to claim 25, wherein the comparison unit determines whether the current capacity is greater than or equal to the capacity threshold, and determines whether the calculated link reliability is greater than or equal to the link reliability threshold, wherein,
if the current capacity is less than the capacity threshold and the calculated link reliability is less than the link reliability threshold, then the adjustment unit increases both the power and the subcarrier usage ratio;
if the current capacity is less than the capacity threshold but the calculated link reliability is greater than or equal to the link reliability threshold, then the adjustment unit just increase the subcarrier usage ratio; and
if the current capacity is greater than or equal to the capacity threshold but the calculated link reliability is less than the link reliability threshold, then the adjustment unit just lowers the subcarrier usage ratio.

30. The base station according to claim 27, wherein,
the comparison unit determines whether the current capacity is greater than or equal to the capacity threshold, and determines whether the calculated link reliability is greater than or equal to the link reliability threshold when the subcarrier usage ratio is lowered by one unit, wherein if yes, then the adjustment unit lowers the subcarrier usage ratio by one unit;
the comparison unit determines whether the current capacity is greater than or equal to the capacity threshold, and determines whether the calculated link reliability is greater than or equal to the link reliability threshold when the power is reduced by one unit, wherein if yes, then the adjustment unit reduces the power by one unit; and
the comparison unit determines whether the current capacity is greater than or equal to the capacity threshold, and determines whether the calculated link reliability is greater than or equal to the link reliability threshold when the power is reduced by one unit but the subcarrier usage ratio is increased by one unit, wherein if yes, then the power is reduced by one unit and the subcarrier usage ratio is increased by one unit.

31. The base station according to claim 25, wherein a controller within whose coverage area the base station is located provides the link reliability threshold, the capacity threshold, a deployment density and a parameter set mapping table for the base stations, wherein the base station selects the initial values of the power and subcarrier usage ratio from the parameter set mapping table from a controller according to the deployment density from the controller.

32. The base station according to claim 25, wherein the subcarrier usage ratio is a ratio of the number of OFDMA subcarriers currently used by the base station to the total number of all usable OFDMA subcarriers.

33. The base station according to claim 25, wherein the calculated link reliability is defined as a probability of an effective CINR being greater than or equal to a lowest CINR.

34. The base station according to claim 25, wherein the base station is a femtocell base station.

35. A controller, adapted for managing at least a first type base station, the controller comprising:
a registration unit, configured for performing registration procedures with the at least a first type base station after the at least a first type base station initiates the registration procedures; and
a calculation unit, configured for obtaining feasible solutions for each one of femtocell deployment densities by off-line simulations, and estimating femtocell deployment density in a coverage area of a second type base station, wherein the at least a first type base station is within the coverage area of the second type base station.

36. The controller according to claim 35, further comprising:
an authentication unit, configured for performing authentication procedures with the at least a first type base station; and
a memory module, comprising a database, wherein the calculation unit stores the femtocell deployment density and parameter sets of the corresponding feasible solutions in a parameter set mapping table, and storing the parameter set mapping table in the database.

37. The controller according to claim 36 further comprising:
a transceiver interface, coupled to a fixed network; and
an administration module, configured for providing the parameter set mapping table and the femtocell deployment density to the at least a first type base station through the fixed network such that the at least a first type base station acquires initial values of power and subcarrier usage ratio according to the femtocell deployment density, and commanding the at least a base station to lower its own capacity threshold when a neighboring second type base station of the at least a first type base station reports to the controller that the neighboring second type base station currently experiences strong interferences from the at least a first type base station.

38. The controller according to claim 35, wherein the first type base station is a femtocell base station, and the second type base station includes a macro cell base station and a micro cell base station.
